(19) United States
(12) Patent Application Publication
(10) Pub. No.: US 2008/0046543 A1
(43) Pub. Date: Feb. 21, 2008

(54) System and method for automatically obtaining web feed content

(75) Inventors: Jeffrey M. Chasen, Redmond, WA (US); Timothy M. Graham, Seattle, WA (US)

Correspondence Address: HOLLAND & KNIGHT LLP, 10 ST. JAMES AVENUE, BOSTON, MA, 02116, US

(73) Assignee: RealNetworks, Seattle, WA (US)

(21) Appl. No.: 11/506,447

(22) Filed: Aug. 18, 2006

(51) Int. Cl. G06F 15/16

(52) U.S. Cl. 709/219

(57) ABSTRACT

A method, computer program product, and electronic device for transferring updated digital content to a client device includes determining that the updated content is available from a web feed. The updated content is obtained from the web feed and stored within a datastore. An indication is provided to the client device, via a network, concerning the availability of the updated content within the datastore. The updated content is transmitted, via the network, from the datastore to the client device.

### TECHNICAL FIELD

This disclosure relates to web feeds and, more particularly, to automatically obtaining updated content from web feeds.

### BACKGROUND

When using a browser to visit websites, web feeds (e.g., Really Simple Syndication (i.e., RSS) feeds, or atom feeds, for example) may be available at the website. Users may use web feed readers to access these feeds and web feed search engines (e.g., www.feedster.com) to search for available web feeds. Typically, the web feed search engines maintain databases that define what web feeds are available on various websites.

On some websites on which web feeds are available, the author of the website may include HTML/XML tags that are indicative of the availability of web feeds on the website. When these websites are viewed by a compatible browser (e.g., Microsoft Internet Explorer™ v7.00), the browser will recognize these tags and indicate to the user the availability of web feeds on the website. However, these HTML/XML tags typically only work on a per page basis (i.e., the tags will not indicate the availability of a web feed on a subpage). Additionally, the web pages must be custom programmed to include the HTML/XML tags and, if the tags are missing, the compatible browser will not know that web feeds are available on the webpage. Additionally, if a webpage (which contains the appropriate HTML/XML tagging) is viewed by a non-compatible browser, the non-compatible browser will not know that web feeds are available on the webpage.

### SUMMARY OF DISCLOSURE

In a first implementation, a method for transferring updated digital content to a client device with an electronic device includes determining that the updated content is available from a web feed. The updated content is obtained from the web feed and stored within a datastore. An indication is provided to the client device, via a network, concerning the availability of the updated content within the datastore. The updated content is transmitted, via the network, from the datastore to the client device.

### BRIEF DESCRIPTION OF THE DRAWINGS

FIG. 1 is a diagrammatic view of a DCT process and a client application coupled to a distributed computing network; and

FIG. 2 is a flowchart of a process executed by the DCT process and/or the client application of FIG. 1.

### DETAILED DESCRIPTION OF THE PREFERRED EMBODIMENTS SYSTEM OVERVIEW:

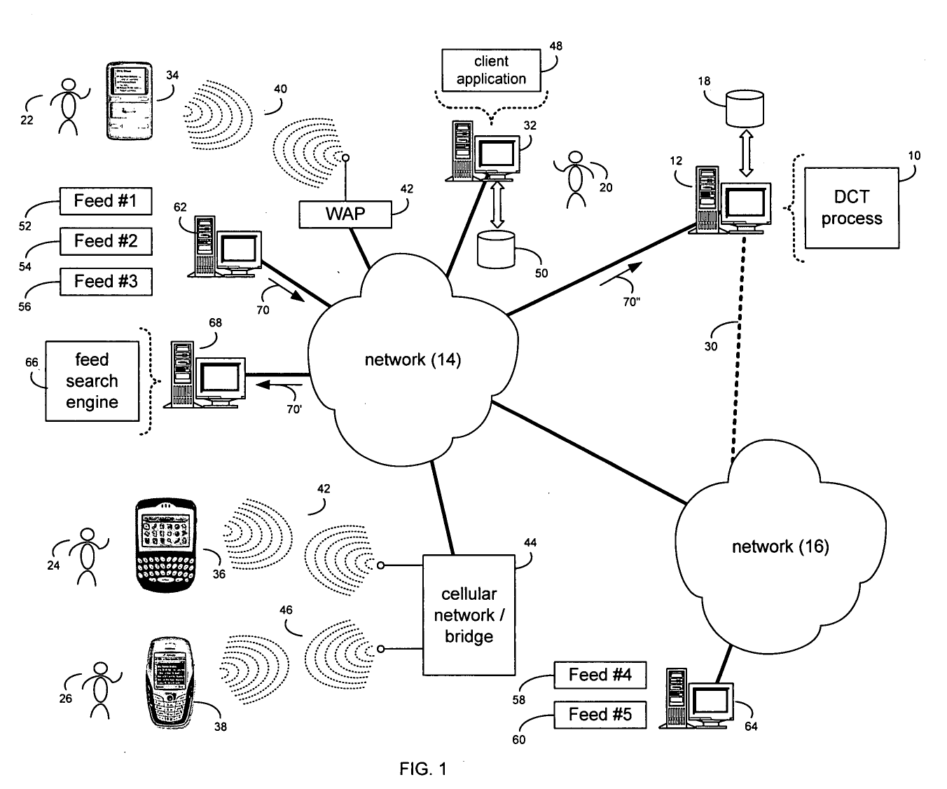

Referring to FIG. 1, there is shown a digital content transfer (i.e., DCT) process 10 that may reside on and be executed by data server 12. As will be discussed below in greater detail, DCT process 10 facilitates the transfer of digital content from various web feeds to various users. Examples of data server 12 may include, but are not limited to, a personal computer, a mini computer, or mainframe computer, for example.

DCT process 10 may be a server application that resides on and is executed by data server 12, which is connected to network 14 (e.g., the Internet). Data server 12 may be a web server (or series of servers) running a network operating system, examples of which may include but are not limited to: Microsoft Windows 2003 Server™; Novell Netware™; or Redhat Linux™, for example.

Data server 12 may also execute a web server application, examples of which may include but are not limited to: Microsoft IIS™, Novell Webserver™, or Apache Webserver™, that allows for HTTP (i.e., HyperText Transfer Protocol) access to data server 12 via network 14. Network 14 may be connected to one or more secondary networks (e.g., network 16), examples of which may include but are not limited to: a local area network; a wide area network; or an intranet, for example.

The instruction sets and subroutines of DCT process 10, which are typically stored on a storage device 18 coupled to data server 12, are executed by one or more processors (not shown) and one or more memory architectures (not shown) incorporated into data server 12. Storage device 18 may include but is not limited to: a hard disk drive; a tape drive; an optical drive; a RAID array; a random access memory (RAM); or a read-only memory (ROM).

Users 20, 22, 24, 26 may access DCT process 10 directly through network 14 or through secondary network 16. Further, data server 12 (i.e., the computer that executes DCT process 10) may be connected to network 14 through secondary network 16, as illustrated with phantom link line 30.

Users 20, 22, 24, 26 may access DCT process 10 through various client devices, examples of which may include but are not limited to client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), for example.

The various client devices may be directly or indirectly coupled to network 14 (or network 16). For example, client computer 32 is shown directly coupled to network 14 via a hardwired network connection. Further, personal media device 34 is shown wirelessly coupled to network 14 via wireless communication channel 40 established between personal media device 34 and wireless access point (i.e., WAP) 42, which is shown directly coupled to network 14. WAP 42 may be, for example, an IEEE 802.11a, 802.11b, 802.11g, Wi-Fi, and/or Bluetooth device that is capable of establishing wireless communication channel 40 between personal media device 34 and WAP 42.

As is known in the art, all of the IEEE 802.11x specifications use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 14 via wireless communication channel 42 established between personal digital assistant 36 and cellular network/bridge 44, which is shown directly coupled to network 14. Further, cellular telephone 38 is shown wirelessly coupled to network 14 via wireless communication channel 46 established between cellular telephone 38 and cellular network/bridge 44.

Client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), may each execute a client application (e.g., client application 48) that interfaces with DCT process 10 and facilitates the transfer of digital content from various web feeds (e.g., web feeds 52, 54, 56, 58, 60) to e.g., users 20, 22, 24, 26.

Client application 48 may be a stand alone application or an applet running within another program, such as Microsoft Internet Explorer™ and Netscape Navigator™, for example). Client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown), may each execute an operating system, examples of which may include but are not limited to Microsoft Windows™, Microsoft Windows CE™, Redhat Linux™, or a custom operating system.

The instruction sets and subroutines of client application 48, which are typically stored on a storage device 50 coupled to e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), or a portable gaming device (e.g., a Sony Playstation™ Portable, not shown), are executed by one or more processors (not shown) and one or more memory architectures (not shown) incorporated into e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), or a portable gaming device (e.g., a Sony Playstation™ Portable, not shown). Storage device 50 may include but is not limited to a hard disk drive, a tape drive, an optical drive, a RAID array, a random access memory (RAM), or a read-only memory (ROM).

### Web Feeds and Web Feed Servers:

As discussed above, when a user (e.g., users 20, 22, 24, 26) visits a website, one or more web feeds (e.g., web feeds 52, 54, 56, 58, 60) may be available at the website. These web feeds are typically hosted by feed servers (e.g., feed servers 62, 64) and accessed and viewed with a web feed reader application. Client application 48 may include or be a portion of a web feed reader application. Accordingly, client application 48 may allow a user to access and review the web feeds.

As discussed above, an example of a web feed is an RSS news feed, which allows for the simplified syndication of digital content via network 14 and/or network 16. Many website, examples of which may include but are not limited to www.foxnews.com, www.cnn.com, www.reuters.com, and www.bbc.com offer digital content (e.g., news headlines and/or stories) via web feeds.

Web feed search engines (e.g., www.feedster.com) 66 allow users to search for available web feeds and determine which web feeds are available at various websites. Web feed search engine 66 may be executed on a computer 68 coupled to network 14 (or network 16) and may maintain one or more databases (not shown) that define the web feeds available on various websites.

Typically, when a web feed (e.g., web feed 52) is added/updated, the feed server (e.g., feed server 62) hosting the added/updated web feed sends a notification (e.g., ping 70) to one or more web feed search engines (e.g., web feed search engine 66). Typically, this notification will provide web feed search engine 66 with all information required to identify and locate the added/updated web feed.

Upon receiving the notification (i.e., represented as received ping 70′), web feed search engine 66 may survey the added/updated web feed (e.g., web feed 52). Additionally, the database(s) (not shown) maintained by web feed search engine 66 may be updated to reflect the added/updated digital content available at the added/modified web feed Web feed search engine 66 may forward received ping 70′ (represented as forwarded ping 70″) to DCT process 10 (being executed by data server 12), thus providing an indication to DCT process 10 that added/updated digital content is available at the added/updated web feed (e.g., web feed 52).

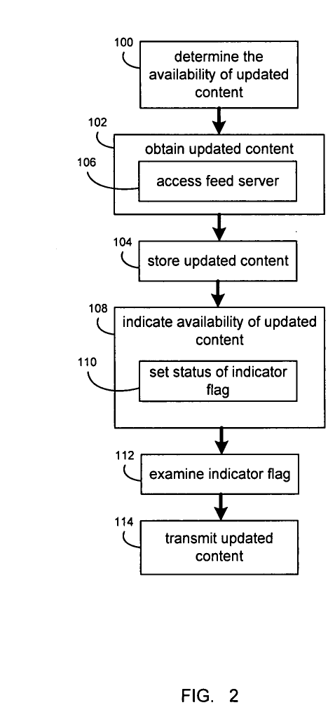

Referring also to FIG. 2, upon receiving forwarded ping 70″ and, thus, determining 100 that updated content is available from e.g., web feed 52, DCT process 10 obtains 102 the updated content from web feed 52 and stores 104 the updated content within a datastore (not shown) accessible and controllable by data server 12. Examples of the datastore (not shown) accessible and controllable by data server 12 may include but are not limited to a database (not shown) servable by the data server 12; a system memory (not shown) accessible by data server 12; and one or more registers (to be discussed below in greater detail; not shown) controllable by data server 12.

The updated content may include but is not limited to any combination of full news stories, news story headlines, video clips, audio clips, weblog files, and graphic files, for example.

While DCT process 10 is described above as receiving forwarded ping 70″ from web feed search engine 66, other configurations are possible and are considered to be within the scope of this disclosure. For example, in addition to feed server 62 sending ping 70 to web feed search engine 66, feed server 62 may directly provide ping 70 to DCT process, thus eliminating the need for web feed search engine 66 to forward received ping 70′ to DCT process 10.

### The Client Application and the DCT Process

As discussed above, the notification received by DCT process 10 from either web feed search engine 66 or feed server 62 identifies and locates the added/updated web feed. An example of such a notification may include http://newsrss.bbc.co.uk/rss/newsonline_uk_edition/front_page/rss.xml, which is a uniform resource locator that locates a particular web feed (e.g., web feed 52).

As discussed above, the various client devices (e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), and a portable gaming device (e.g., a Sony Playstation™ Portable, not shown) may execute a client application (e.g., client application 48) that interfaces with DCT process 10 and facilitates the transfer of content from various web feeds (e.g., web feeds 52, 54, 56, 58) to e.g., users 20, 22, 24, 26.

Client application 48 may allow the user (e.g., user 20) to select which of various available web feeds the user wishes to subscribe to. For example, of the five available web feeds (e.g., web feeds 52, 54, 56, 58, 60), assume that user 20 subscribes to three of them (namely web feeds 52, 56, 60) using client application 48.

As discussed above, whenever DCT process 10 determines 100 that updated content is available from a web feed, DCT process 10 may access 106 the feed server hosting the web feed to obtain 102 the updated content from the web feed. This updated content may then be stored 104 within a datastore (not shown) that is accessible and controllable by data server 12.

DCT process 10 may maintain an indicator flag for each of the web feeds being monitored by DCT process 10, wherein the status of the indicator flag indicates the status of the content stored within the datastore and associated with the web feed. For example, a one-bit flag having a content of a binary “1” may indicate the availability of updated content, while a content of a binary “0” may indicate that no new content is available. The indicator flags maintained by DCT process 10 may be maintained within one or more registers of the datastore. Accordingly, assuming that DCT process 10 determines 100 that web feeds 54, 56, 58 have be updated, the updated content may be obtained 102 from the three respective web feeds and stored 104 within the datastore. DCT process 10 may provide 108 an indication to the various client devices (e.g., client computer 32, personal media device 34, personal digital assistant 36, cellular telephone 38) that updated content is available concerning these web feeds. DCT process 10 may provide 108 this indication by setting 110 the status of an indicator flag to indicate the availability of updated content within the datastore concerning the updated web feeds.

Client application 48 may periodically interface with DCT process 10. This interfacing process may occur during specific events (e.g., during client device startup or upon launching of client application 48) or on a periodic basis (e.g., every five minutes). During the interfacing operation, client application 48 may examine 112 the status of the indicator flags for each of the web feeds to which the user is subscribed. Continuing with the above-described example, as user 20 subscribed (via client application 48) to three web feeds, namely web feeds 52, 56, 60, upon client application 48 interfacing with DCT process 10, client application 48 may examine the status of the indicator flag associated with each of the three web feeds to determine if updated content is available for each web feed.

In the event that client application 48 determines (by examining 112 the status of the indicator flags) that updated content is available for web feed 56, the updated content (which is currently stored within the datastore) is transmitted 114 from the datastore to the client device (e.g., client computer 32).

While the system is described above as requiring that the client application periodically interface with DCT process 10 so that the indicator flags associated with the various web feeds can be examined to determine if updated content is available for any web feeds to which the user subscribes, other configurations are possible and are considered to be within the scope of this disclosure. For example, upon DCT process 10 determining 100 that updated content is available for a web feed, all users may be notified of the available updated content. This notification may occur by having DCT process 10 notify the client application 48 of the various users (e.g., users 20, 22, 24, 26) that updated content is available for one or more web feeds. The client applications may then each determine if the user of the client application subscribes to the updated web feed. If so, the individual client applications may request the updated content from DCT process 10 and the updated content may be transmitted 114 (via network 14 and/or network 16) to the individual client devices.

Additionally, when a client application interfaces with DCT process 10, the interfacing client application may define the specific web feeds (e.g., web feeds 52, 56, 60) that the user (e.g., user 20) has subscribed to. For example, client application 48 may provide to DCT process 10 one or more uniform resource locators, each of which defines the location of a web feed to which the user has subscribed. Accordingly, as DCT process 10 knows the specific web feeds that a particular user (e.g., user 20) is subscribed to, if DCT process 10 notifies client applications of the availability of updated content for various web feeds, DCT process 10 may be configured to only notify a client application of updated content if the user associated with the client application subscribes to the updated web feed. For example and as discussed above, user 20 subscribes to three of the five available web feeds, namely web feeds 52, 56, 60. If web feed 54 is updated, when DCT process 10 notifies the client applications of the available of updated content for web feed 54, client application 48 (i.e., the client applications used by user 20) may not be notified, as user 20 does not subscribe to web feed 54.

Concerning the indicator flags maintained by DCT process 10 to identify the status of the content of each of the web feeds, these indicator flags may be configured and maintained by DCT process 10 in various fashions. For example, a single indicator flag may be maintained for each web feed being monitored. As discussed above, the status of this indicator flag may be set from “0” to “1” upon updated content being obtained for the related web feed. This status “1” indicator flag may be maintained for a defined period of time prior to being reset to “0”. This defined period of time may be sized long enough to ensure that each client application has had enough time to interface with DCT process 10 and to download the updated content associated with the web feed. For example, if each client application interfaces with DCT process 10 every five minutes, the status “1” indicator flag may be maintained for at least five minutes to ensure that the client application went through an interface cycle.

Alternatively, an indicator flag (for each web feed) may be maintained for each user. For example, assume that five users subscribe to web feed 52. One indicator flag may be maintained for each user subscribing to the web feed (for a total of five indicator flags). Therefore, when updated content becomes available for web feed 52, the status of each of the five indicator flags may be set to “1” (thus indicating the availability of updated content for web feed 52). As each of the client applications associated with each of the five users interfaces with DCT process 10, the updated content will be transmitted 114 to the client device and the indicator flag (for the interfacing client device) may be set to a “0” status.

A number of implementations have been described. Nevertheless, it will be understood that various modifications may be made. Accordingly, other implementations are within the scope of the following claims.

What is claimed is:

1. A method of transferring updated digital content to a client device with an electronic device, the method comprising:
determining that the updated content is available from a web feed;
obtaining the updated content from the web feed;
storing the updated content within a datastore;
indicating to the client device, via a network, the availability of the updated content within the datastore; and
transmitting, via the network, the updated content from the datastore to the client device.

2. The method of claim 1 wherein indicating to a client device includes:
setting the status of an indicator flag to indicate the availability of the updated content within the datastore;
wherein the status of the indicator flag is examinable by the client device.

3. The method of claim 2 wherein the client device executes a client application, the method further comprising:
periodically examining, via the client application, the status of the indicator flag.

4. The method of claim 1 wherein:
the electronic device is a data server;
a feed server, which hosts the web feed, provides an indication concerning the availability of updated content from the web feed; and
determining that updated content is available includes receiving the indication on the data server.

5. The method of claim 4 wherein:
the datastore is included within the data server;
obtaining the updated content from the web feed includes accessing the feed server to obtain the updated content; and
storing the updated content within a datastore includes storing the updated content within the datastore of the data server.

6. The method of claim 1 wherein the datastore includes one or more of: a database servable by the electronic device; a system memory accessible by the electronic device; and a register controllable by the electronic device.

7. The method of claim 1 wherein the client device is chosen from the group consisting of: a desktop computer; a laptop computer a notebook computer; a personal digital assistant; a wireless network device; a cable television box; a television, a gaming device, and a cellular telephone.

8. A computer program product residing on a computer readable medium, within an electronic device, having a plurality of instructions stored thereon that, when executed by a processor, cause the processor to perform operations comprising:
determining that updated content is available from a web feed;
obtaining the updated content from the web feed;
storing the updated content within a datastore;
indicating to a client device, via a network, the availability of the updated content within the datastore; and
transmitting, via the network, the updated content from the datastore to the client device.

9. The computer program product of claim 8 wherein the instructions for indicating to a client device include instructions for performing operations comprising:
setting the status of an indicator flag to indicate the availability of the updated content within the datastore;
wherein the status of the indicator flag is examinable by the client device.

10. The computer program product of claim 9 wherein the client device executes a client application, the computer program product further comprising instructions for performing operations comprising:
periodically examining, via the client application, the status of the indicator flag.

11. The computer program product of claim 8 wherein:
the electronic device is a data server;
a feed server, which hosts the web feed, provides an indication concerning the availability of updated content from the web feed; and
the instructions for determining that updated content is available include instructions for performing operations comprising receiving the indication on the data server.

12. The computer program product of claim 8 wherein:
the datastore is included within the data server;
the instructions for obtaining the updated content from the web feed include instructions for performing operations comprising accessing the feed server to obtain the updated content; and
the instructions for storing the updated content within a datastore include instructions for performing operations comprising storing the updated content within the datastore of the data server.

13. The computer program product of claim 8 wherein the datastore includes one or more of: a database servable by the electronic device; a system memory accessible by the electronic device; and a register controllable by the electronic device.

14. The computer program product of claim 8 wherein the client device is chosen from the group consisting of: a desktop computer; a laptop computer a notebook computer; a personal digital assistant; a wireless network device; a cable television box; a television, a gaming device, and a cellular telephone.

15. An electronic device configured to perform operations comprising:
determining that updated content is available from a web feed;
obtaining the updated content from the web feed;
storing the updated content within a datastore;
indicating to a client device, via a network, the availability of the updated content within the datastore; and
transmitting, via the network, the updated content from the datastore to the client device.

16. The electronic device of claim 15 wherein indicating to a client device includes:
setting the status of an indicator flag to indicate the availability of the updated content within the datastore;
wherein the status of the indicator flag is examinable by the client device.

17. The electronic device of claim 16 wherein the client device is configured to perform operations comprising:
periodically examining, via the client application, the status of the indicator flag.

18. The electronic device of claim 15 wherein:
a feed server, which hosts the web feed, provides an indication concerning the availability of updated content from the web feed; and
determining that updated content is available includes receiving the indication on the electronic device.

19. The electronic device of claim 18 wherein:
the datastore is included within the electronic device;
obtaining the updated content from the web feed includes accessing the feed server to obtain the updated content; and
storing the updated content within a datastore includes storing the updated content within the datastore of the electronic device.

20. The electronic device of claim 15 wherein the datastore includes one or more of: a database servable by the electronic device; a system memory accessible by the electronic device; and a register controllable by the electronic device.

21. The electronic device of claim 15 wherein the client device is chosen from the group consisting of: a desktop computer; a laptop computer a notebook computer; a personal digital assistant; a wireless network device; a cable television box; a television, a gaming device, and a cellular telephone.
